(19) United States
(12) Patent Application Publication
(10) Pub. No.: US 2026/0352828 A1
(43) Pub. Date: Nov. 5, 2026

(54) Method and Apparatus of Entropy Coding for Subpictures

(71) Applicant: MEDIATEK INC., Hsinchu City (TW)

(72) Inventor: Shih-Ta HSIANG, Hsinchu City (TW)

(21) Appl. No.: 19/105,102

(22) PCT Filed: Aug. 8, 2023
(86) PCT No.: PCT/CN2023/111643

§ 371 Date: Feb. 20, 2025

Related U.S. Application Data
(60) Provisional application No. 63/373,471, filed on Aug. 25, 2022.

(51) Int. Cl. H04N 19/13; H04N 19/172; H04N 19/174; H04N 19/70

(52) U.S. Cl. CPC H04N 19/13; H04N 19/172; H04N 19/174; H04N 19/70

(57) ABSTRACT

A method and apparatus of context initialization for entropy coding of subpictures. According to this method, previous context states for an arithmetic entropy coder are determined, where one or more context state buffers are used to store the previous context states for initializing the arithmetic entropy coder. When a subpicture coding tool is used for the current picture: initializing the arithmetic entropy coder using the previous context states stored in said one or more context state buffers is disabled; and the input data is encoded or decoded using the arithmetic entropy coder. In another embodiment, a video coder may only allow initialization of context states for entropy coding a current subpicture using the stored set of context states that is generated after entropy coding an inter slice corresponding to the same subpicture in a coded previous picture.

### CROSS REFERENCE TO RELATED APPLICATIONS

The present invention is a non-Provisional Application of and claims priority to U.S. Provisional Patent Application No. 63/373,471, filed on Aug. 25, 2022. The U.S. Provisional Patent Application is hereby incorporated by reference in its entirety.

### FIELD OF THE INVENTION

The present invention relates to video coding system. In particular, the present invention relates to context initialization for entropy coding subpictures in a video coding system to improve the coding performance.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an entropy decoder 140 to decode the video bitstream into quantized transform coefficients and needed coding information (e.g., ILPF information, Intra prediction information and Inter prediction information). The Intra prediction 150 at the decoder side does not need to perform the mode search. Instead, the decoder only need to generate Intra prediction according to Intra prediction information received from the Entropy Decoder 140. Furthermore, for Inter prediction, the decoder only needs to perform motion compensation (MC 152) according to Intra prediction information received from the Entropy Decoder 140 without the need for motion estimation.

A coded video sequence can be represented by a collection of coded layered video sequences. A coded layered video sequence can be further divided into more than one temporal sublayer. Each coded video data unit belongs to one particular layer identified by the layer index (ID) and one particular sublayer ID identified by the temporal ID. Both layer ID and sublayer ID are signalled in a network abstraction layer (NAL) header. A coded video sequence can be recovered at reduced quality or frame rate by skipping video data units belonging to one or more highest layers or sublayers. The video parameter set (VPS), the sequence parameter set (SPS) and the picture parameter set (PPS) contain high-level syntax elements that apply to a coded video sequence, a coded layered video sequence and a coded picture, respectively. The picture header (PH) and slice header (SH) contain high-level syntax elements that apply to a current coded picture and a current coded slice, respectively.

In VVC, a coded picture is partitioned into non-overlapped square block regions represented by the associated coding tree units (CTUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types (quad-tree partitioning 210, vertical binary tree partitioning 220, horizontal binary tree partitioning 230, vertical centre-side triple-tree partitioning 240, horizontal centre-side triple-tree partitioning 250) illustrated in FIG. 2. FIG. 3 provides an example of a CTU recursively partitioned by QT with the nested MTT. Each CU contains one or more prediction units (PUs). The prediction unit, together with the associated CU syntax, works as a basic unit for signalling the predictor information. The specified prediction process is employed to predict the values of the associated pixel samples inside the PU. Each CU may contain one or more transform units (TUs) for representing the prediction residual blocks. A transform unit (TU) comprises of a transform block (TB) of luma samples and two corresponding transform blocks of chroma samples and each TB correspond to one residual block of samples from one colour component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one colour component associated with CTU, CU, PU, and TU, respectively. Thus, a CTU consists of one luma CTB, two chroma CTBs, and associated syntax elements. A similar relationship is valid for CU, PU, and TU.

For achieving high compression efficiency, the context-based adaptive binary arithmetic coding (CABAC) mode, or known as regular mode, is employed for entropy coding the values of the syntax elements in HEVC and VVC. FIG. 4 illustrates an exemplary block diagram of the CABAC process. Since the arithmetic coder in the CABAC engine can only encode the binary symbol values, the CABAC process needs to convert the values of the syntax elements into a binary string using a binarizer (410). The conversion process is commonly referred to as binarization. During the coding process, the probability models are gradually built up from the coded symbols for the different contexts. The context modeller (420) serves the modelling purpose. During normal context based coding, the regular coding engine (430) is used, which corresponds to a binary arithmetic coder. The selection of the modelling context for coding the next binary symbol can be determined by the coded information. Symbols can also be encoded without the context modelling stage and assume an equal probability distribution, commonly referred to as the bypass mode, for reduced complexity. For the bypassed symbols, a bypass coding engine (440) may be used. As shown in FIG. 4, switches (S1, S2 and S3) are used to direct the data flow between the regular CABAC mode and the bypass mode. When the regular CABAC mode is selected, the switches are flipped to the upper contacts. When the bypass mode is selected, the switches are flipped to the lower contacts as shown in FIG. 4.

As the arithmetic coder in the CABAC engine can only encode the binary symbol values, the CABAC operation first needs to convert the value of a syntax element into a binary string, the process commonly referred to as binarization. During the coding process, the accurate probability models are gradually built up from the coded symbols for the different contexts. A set of storage units is allocated to trace the on-going context state, including accumulated probability state, for individual modelling contexts. The context states are initialized using the pre-defined modelling parameters for each context according to the specified slice QP. The selection of a particular modelling context for coding a binary symbol can be determined by a pre-defined rule or derived from the coded information. Symbols can be coded without the context modelling stage and assume an equal probability distribution, commonly referred to as the bypass mode, for improving bitstream parsing throughput rate.

In VVC, a tile is a sequence of CTUs that covers a rectangular region of a picture. The CTUs in a tile are scanned in a raster scan order within the tile. A picture is divided into one or more tile rows and one or more tile columns. A slice consists of an integer number of complete tiles or an integer number of consecutive complete CTU rows within a tile of a picture. Two modes of slices are supported, namely the raster-scan slice mode and the rectangular slice mode, indicated by the syntax element rect_slice flag. In the raster-scan slice mode, a slice contains a sequence of complete tiles in a tile raster scan of a picture. In the rectangular slice mode, a slice contains either a number of complete tiles that collectively form a rectangular region of the picture or a number of consecutive complete CTU rows of one tile that collectively form a rectangular region of the picture. Tiles within a rectangular slice are scanned in a tile raster scan order within the rectangular region corresponding to the slice. A subpicture contains one or more slices that collectively cover a rectangular region of a picture. Subpictures are identified by assigned subpicture indices in a coded video sequence. FIG. 5 provides an example of partitioning a picture into 18 tiles, 24 slices/24 subpictures. As shown in FIG. 5, the picture 510 is partitioned into 18 tiles (514), 12 on the left-hand side each covering one slice of 4 by 4 CTUs and 6 tiles on the right-hand side each covering 2 vertically-stacked slices of 2 by 2 CTUs, altogether resulting in 24 slices (516)/24 subpictures (516) of varying dimensions (each slice is also a subpicture). Each small rectangle 512 corresponds to one CTU.

Joint Video Expert Team (JVET) of ITU-T SG16 WP3 and ISO/IEC JTC1/SC29 are currently in the process of exploring the next-generation video coding standard. Some promising new coding tools have been adopted into Enhanced Compression Model 5 (ECM 5) (M. Coban, et al., “Algorithm description of Enhanced Compression Model 5 (ECM 5),” Joint Video Expert Team (JVET) of ITU-T SG 16 WP 3 and ISO/IEC JTC 1/SC 29, 26th Meeting, by teleconference, 20-29 Apr. 2022, Document JVET-Z 2025) to further improve VVC. The adopted new tools have been implemented in the reference software ECM-5.0 (available online: https://vcgit.hhi.fraunhofer.de/ecm/ECM).

The present invention is intended to overcome issues related to context state initialization for entropy coding subpictures.

### BRIEF SUMMARY OF THE INVENTION

A method and apparatus of context initialization for entropy coding are disclosed. According to this method, input data are received, wherein the input data comprise binary symbols for a set of syntax elements associated with a current slice in a current subpicture of a current picture at an encoder side, or entropy coded bitstream of the binary symbols for the set of syntax elements at a decoder side, and wherein the current slice is inter coded. Previous context states for an arithmetic entropy coder are determined, wherein one or more context state buffers are used to store the previous context states for initializing the arithmetic entropy coder. When a subpicture coding tool is used for the current picture: initializing the arithmetic entropy coder using the previous context states stored in said one or more context state buffers is disabled; and the input data is encoded or decoded using the arithmetic entropy coder.

In one embodiment, when the subpicture coding tool is used for the current picture, the arithmetic entropy coder is initialized by using pre-defined context states.

In one embodiment, the method further comprises, when the subpicture coding tool is used for the current picture, a conforming bitstream is generated at the encoder side or received at the decoder side, wherein syntax information always indicates initialization of context states using the previous context states stored in said one or more context state buffers is disabled.

According to another method, input data are received, wherein the input data comprise binary symbols for a set of syntax elements associated with a current slice in a current subpicture of a current picture at an encoder side, or entropy coded bitstream of the binary symbols for the set of syntax elements at a decoder side, and wherein the current slice is inter coded. Previous context states for an arithmetic entropy coder are determined, wherein one or more context state buffers are used to store the previous context states for initializing the arithmetic entropy coder. The arithmetic entropy coder is initialized by using the previous context states stored in said one or more context state buffers, wherein only the previous context states generated after entropy coding one or more previous inter slices corresponding to a same subpicture index of a coded previous subpicture as a current subpicture index of the current subpicture are allowed for said initializing the arithmetic entropy coder. The input data is encoded or decoded using the arithmetic entropy coder.

In one embodiment, when a set of context states associated with the current subpicture index for the current subpicture is not available in the previous context states, the arithmetic entropy coder is not initialized using the previous context states for entropy coding one or more inter slices in the current subpicture.

According to another method, input data are received, wherein the input data comprise binary symbols for a set of syntax elements associated with a current slice in a current subpicture of a current picture at an encoder side, or entropy coded bitstream of the binary symbols for the set of syntax elements at a decoder side, and wherein the current slice is inter coded. Previous context states generated by entropy coding a subpicture are determined for an arithmetic entropy coder, wherein the previous context states are stored in multiple context state buffers and different context state buffers are used to store the previous context states for different subpicture ID. A set of target context states is determined, from the previous context states, for the current slice in the current subpicture indicated by a current subpicture ID according to current coding parameters comprising the current subpicture ID. A current set of context states for the arithmetic entropy coder is initialized using the set of target context states. The input data is encoded or decoded using the arithmetic entropy coder after said initializing the current set of context states for the arithmetic entropy coder. The current set of context states, generated from said encoding or decoding the input data, are stored in the multiple context state buffers after entropy coding the current subpicture in the current picture.

In one embodiment, the previous context states generated from entropy coding one subpicture having a same slice type, a same QP, a same temporal ID, and a same subpicture ID as corresponding values of respective slice type, QP, temporal ID, and subpicture ID associated with the current slice are stored in one context state buffer.

In one embodiment, each of the multiple context state buffers only stores one or more sets of context states generated from entropy coding one or more subpictures corresponding to the same subpicture ID in a coded video sequence.

In one embodiment, the set of target context states is derived from two or more sets of context states stored in the multiple context state buffers. In one embodiment, one or more syntaxes are signalled or parsed to indicate said two or more sets of context states used to derive the set of target context states.

In one embodiment, the multiple context state buffers correspond to a four-dimensional array of context state buffers with a slice type, a temporal ID, a layer ID and a subpicture ID as four dimensions. In one embodiment, different values of maximum context state buffer sizes are set for the different context state buffers. In one embodiment, the maximum context state buffer sizes are pre-defined. In another embodiment, the maximum context state buffer sizes are explicitly signalled or parsed in a high-level syntax of a bitstream.

In one embodiment, a total context state buffer size is limited by one or more constraints defined for a particular profile, tier, or level associated with a current coded video sequence.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates that a CU can be split into smaller CUs using one of the five split types (quad-tree partitioning, vertical binary tree partitioning, horizontal binary tree partitioning, vertical centre-side triple-tree partitioning, and horizontal centre-side triple-tree partitioning).

FIG. 3 illustrates an example of a CTU being recursively partitioned by QT with the nested MTT.

FIG. 4 illustrates an exemplary block diagram of the CABAC process.

FIG. 5 provides an example of partitioning a picture into 18 tiles, 24 slices and 24 subpictures.

FIG. 6 illustrates a flowchart of an exemplary video coding system that comprises entropy coding for subpictures according to an embodiment of the present invention.

FIG. 7 illustrates a flowchart of an exemplary video coding system that comprises entropy coding for subpictures according to an embodiment of the present invention.

FIG. 8 illustrates a flowchart of an exemplary video coding system that uses multiple sets of context states for initialization of entropy coding subpictures according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In ECM 5, the set of the context states after entropy coding the last CTU in a coded inter picture can be used to initialize the set of the context states for entropy coding a future inter slice having the same slice type, quantization parameter (QP), and temporal ID (TID) as the coded picture. A new set of the context states after entropy coding a current inter picture is stored in an assigned entry of a context state buffer in a video coder. When a stored set of context states that is generated by entropy coding a previous inter slice having the same slice type, QP, and TID as the current picture can be found in the context state buffer, the new set of the context states just replaces the stored set of context states corresponding to the same slice type, QP, and TID in the context state buffer. Otherwise, the new set of the context states is assigned to be stored in an empty entry in the context state buffer. When the context state buffer is already full, the stored context set associated with the entry having the smallest QP and temporal ID is removed first from the context state buffer before storing the new set of context states. In ECM-5.0 reference software implementation, an array of context state buffers ctxStateBuffers[NumInterSliceTypes] is created for storage of the sets of context states corresponding to different slice types, wherein NumInterSliceTypes indicates the number of different slice types and is equal to 2 (referring to B and P slice types in ECM 5). Each context state buffer stores the sets of context states that are resulted from entropy coding inter slices in previous pictures using one particular slice type. The allowed maximum buffer size is fixed to be equal to 5 (sets of context states) for each of the two context state buffers. The context state for each context in a stored set may include entries for tracing long-term probability, short-term probability, and weighting factors for deriving the predicted probability.

Before starting entropy coding a current inter slice, the ECM 5 video coder will first search the context state buffer for a stored set of context states having the same slice type, QP, and TID as the current slice. The slice type, QP, and TID are referred as coding parameters in this disclosure. Accordingly, a set of context states is stored for each coding parameter combination (i.e., slice type, QP, and TID). If such a stored set can be found, the video coder will copy each context state in the stored set to the corresponding context state in the current slice. Otherwise, the set of the context states in the current slice are not initialized by any stored set of context states in the context state buffer. The context states in the current slice are just initialized by the pre-defined default method in VVC.

In VVC, a coded picture can be divided into a plurality of coded subpictures. Each coded subpicture can be extracted from a single bitstream and decoded independently from other coded subpictures. However, in ECM 5, the set of context states for entropy coding one or more inter slices in a particular subpicture of a current picture is initialized from a stored set of context states that is generated after entropy coding the last CTU in a coded previous picture. As a result, entropy coding a particular subpicture in the current picture is dependent on the coded subpicture containing the last CTU in the coded previous picture. Individual subpictures can no longer be decoded independently.

In one proposed method, a video coder may disable the initialization of context states for entropy coding a subpicture based on a stored set of context states resulted from entropy coding a different subpicture. The individual subpictures can be identified by subpicture indices or other pre-defined methods. In some embodiments, a video coder may disable the initialization of context states from the stored set of context states entirely when the subpicture coding tool is used in a current coded video sequence. The video coder can be forced to disable the initialization of context states from the stored set of context states in the encoding or decoding process when the subpicture coding tool is enabled, or more than one subpicture is present in the current video sequence. Alternatively, the video coder may comprise a bitstream conformance requirement that the syntax information shall indicate the initialization of context states from the stored set of context states being disable when the subpicture coding tool is enabled, or more than one subpicture is present in the current coded video sequence.

In another method, a video coder may only allow the initialization of context states for entropy coding a current subpicture using the stored set of context states that is generated after entropy coding an inter slice corresponding to the same subpicture, identified by a subpicture index or other pre-defined methods, in a coded previous picture. For entropy coding a current subpicture with a subpicture index SubpicId, when a video coder cannot find any stored set of context states corresponding to the same subpicture index SubpicId, the context states are not initialized from a stored set of context states for entropy coding the current subpicture.

In another method, a video coder may store more than one set of context states corresponding to different subpictures after entropy coding a picture. The video coder may initialize the context states for entropy coding a current inter slice in a current subpicture using one or more stored sets of context states generated by entropy coding previous slices corresponding to a same subpicture ID as a current subpicture ID of the current subpicture. In one preferred embodiment, the video coder may initialize the context states for entropy coding a current inter slice in a subpicture using a stored set of context states, wherein the stored set of context states is generated by entropy coding a subpicture in a previous picture having the same slice type, QP, TID, and subpicture ID as the current slice. In one embodiment, the video coder may store one or more sets of context states after entropy coding each of subpictures in a picture. The video coder may maintain separate context state buffers for different subpictures. Each context state buffer only stores the sets of context states that are generated from the coded subpictures corresponding to the same subpicture ID in a coded video sequence. In some embodiments, when more than one set of stored context states can be used for the initialization of a set of context states for entropy coding a current slice, a video coder may further comprise signalling one or more syntax elements to indicate the selected set of stored context states for initialization of the set of context states for entropy coding the current slice.

In one embodiment, a video coder may create a two-dimensional array of context state buffers ctxStateBuffers[Num SubPictures][NumInterSliceTypes] for storage of the sets of context states generated from different subpictures and slice types, wherein NumSubPictures indicates the number of subpictures in a coded video sequence. Each context state buffer ctxStateBuffers[subpicId][SliceType] only stores the sets of context states that are generated from coded inter slices having a subpicture ID equal to subpicIs and a slice type equal to SliceType. In another embodiment, a video coder may create a three-dimensional array of context state buffers ctxStateBuffers[NumSubLayers][NumSubPictures][NumInterSliceTypes] for storage of the sets of context states generated from different temporal sublayers, subpictures and slice types, wherein NumSubLayers indicates the number of temporal sublayers in a coded video sequence. Each context state buffer ctxStateBuffers [TemporalId] [subpicId][SliceType] only stores the sets of context states that are generated from coded inter slices having a TID equal to TemporalId, a subpicture ID equal to subpicId, and a slice type equal to SliceType. In another embodiment, a video coder may create a four-dimensional array of context state buffers ctxStateBuffers [NumLayers][NumSubLayers][Num SubPictures][NumInterSliceTypes] for storage of the sets of context states generated from different subpictures, temporal sublayers, and slice types, wherein NumLayers indicates the number of layers in a coded video sequence. Each context state buffer ctxStateBuffers[LayerId][TemporalId][subpicId][SliceType] only stores the sets of context states that are generated from coded inter slices having a layer index equal to LayerId, a TID equal to TemporalId, a subpicture ID equal to subpicId, and a slice type equal to SliceType.

The video coder may set different values of maximum context state buffer sizes for different context state buffers, wherein the maximum context state buffer sizes can be either pre-defined or explicitly signalled in the bitstream, such as in the SPS or PPS. In some embodiments, the total context state buffer size may be limited by the constraint defined for a particular profile, tier, or level associated with a current coded video sequence.

The proposed methods can be jointly supported in a video coder. The video coder may further comprise signalling one or more high-level syntax elements in the high-level syntax set such as the SPS, PPS, PH, and SH to indicate which method is selected for context initialization in a current video sequence.

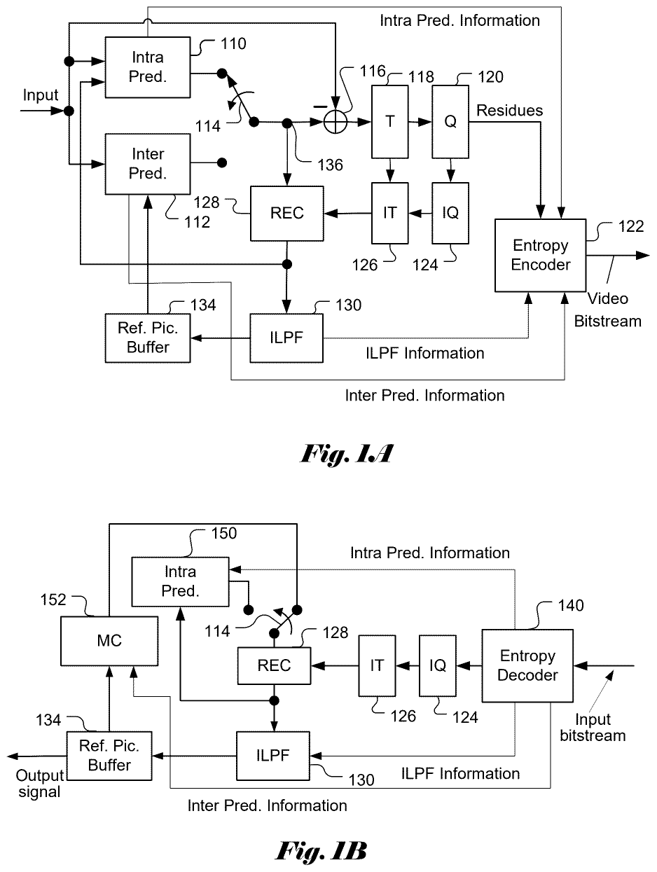

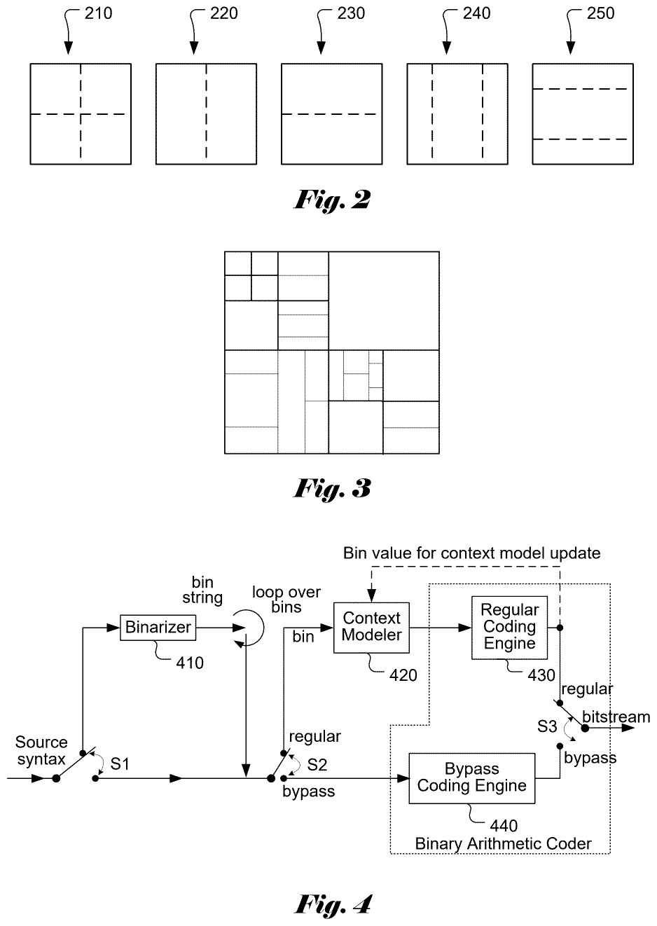

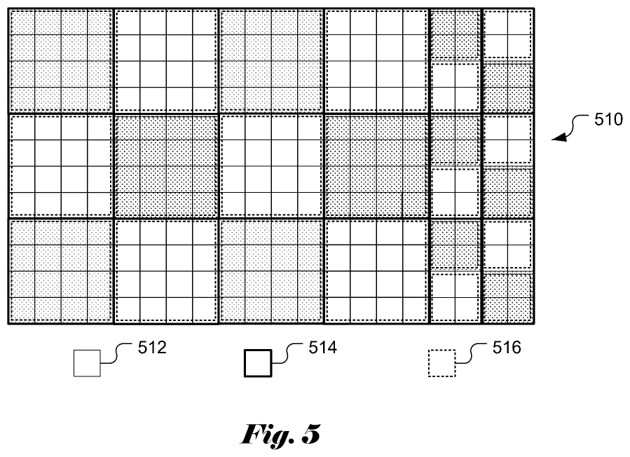

Any of the foregoing proposed entropy coding methods for subpictures can be implemented in encoders and/or decoders. For example, any of the proposed entropy coding methods can be implemented in the entropy coding module (e.g., Entropy Encoder 122 in FIG. 1A) of an encoder, and/or the entropy coding module (e.g., Entropy Decoder 140 in FIG. 1B) of a decoder. Alternatively, any of the proposed methods can be implemented as a circuit integrated to the entropy coding module of an encoder, and/or the entropy coding module of a decoder. The proposed aspects, methods and related embodiments can be implemented individually and jointly in a video coding system.

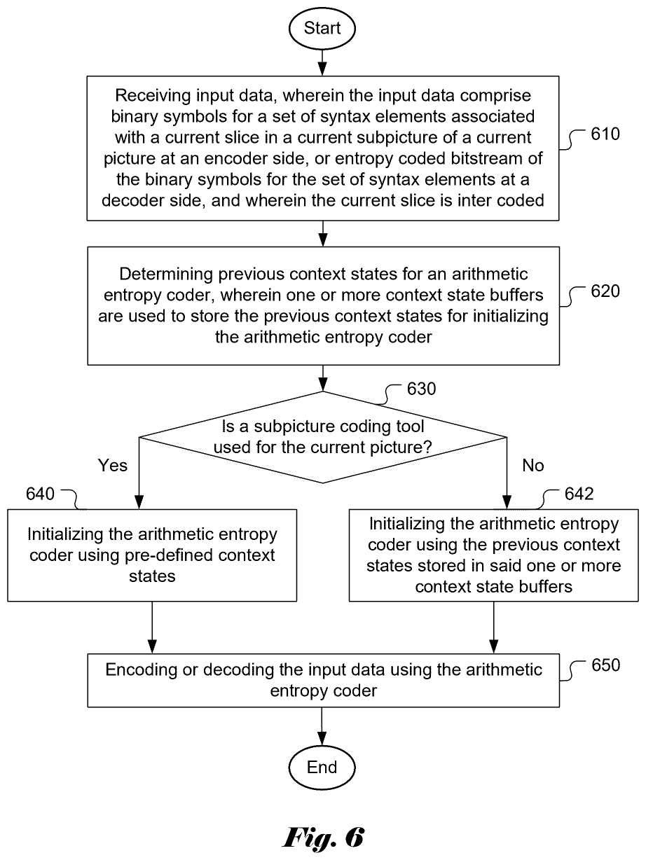

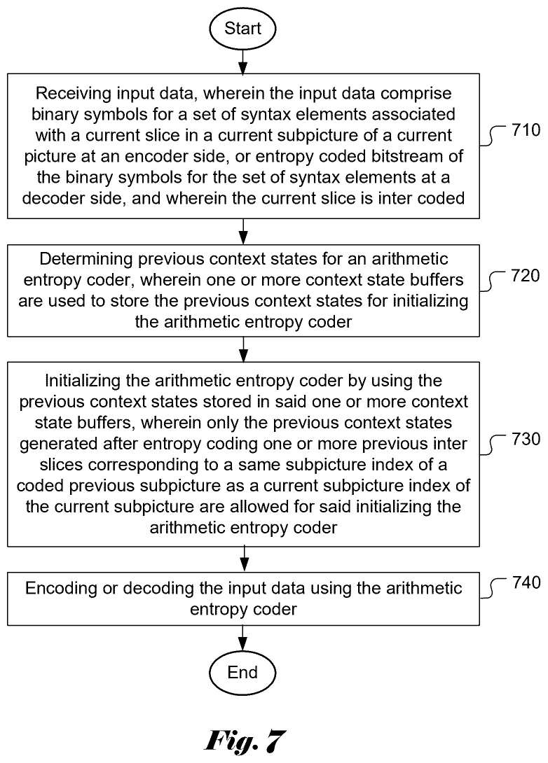

FIG. 6 illustrates a flowchart of an exemplary video coding system that comprises entropy coding for subpictures according to an embodiment of the present invention. The steps shown in the flowchart may be implemented as program codes executable on one or more processors (e.g., one or more CPUs) at the encoder/decoder side. The steps shown in the flowchart may also be implemented based hardware such as one or more electronic devices or processors arranged to perform the steps in the flowchart. According to this method, input data are received in step 610, wherein the input data comprise binary symbols for a set of syntax elements associated with a current slice in a current subpicture of a current picture at an encoder side, or entropy coded bitstream of the binary symbols for the set of syntax elements at a decoder side, and wherein the current slice is inter coded. Previous context states for an arithmetic entropy coder are determined in step 620, wherein one or more context state buffers are used to store the previous context states for initializing the arithmetic entropy coder. Whether a subpicture coding tool is used for the current picture is checked in step 630. If the subpicture coding tool is used for the current picture (i.e., the “Yes” path in step 630), step 640 is performed. If the subpicture coding tool is not used for the current picture (i.e., the “No” path in step 630), step 642 is performed. In step 640, the arithmetic entropy coder is initialized using pre-defined context states. In step 642, the arithmetic entropy coder is initialized using the previous context states stored in said one or more context state buffers. In step 650, the input data is encoded or decoded using the arithmetic entropy coder.

FIG. 7 illustrates a flowchart of an exemplary video coding system that comprises entropy coding for subpictures according to an embodiment of the present invention. According to this method, input data are received in step 710, wherein the input data comprise binary symbols for a set of syntax elements associated with a current slice in a current subpicture of a current picture at an encoder side, or entropy coded bitstream of the binary symbols for the set of syntax elements at a decoder side, and wherein the current slice is inter coded. Previous context states for an arithmetic entropy coder are determined in step 720, wherein one or more context state buffers are used to store the previous context states for initializing the arithmetic entropy coder. The arithmetic entropy coder is initialized by using the previous context states stored in said one or more context state buffers in step 730, wherein only the previous context states generated after entropy coding one or more previous inter slices corresponding to a same subpicture index of a coded previous subpicture as a current subpicture index of the current subpicture are allowed for said initializing the arithmetic entropy coder. The input data is encoded or decoded using the arithmetic entropy coder in step 740.

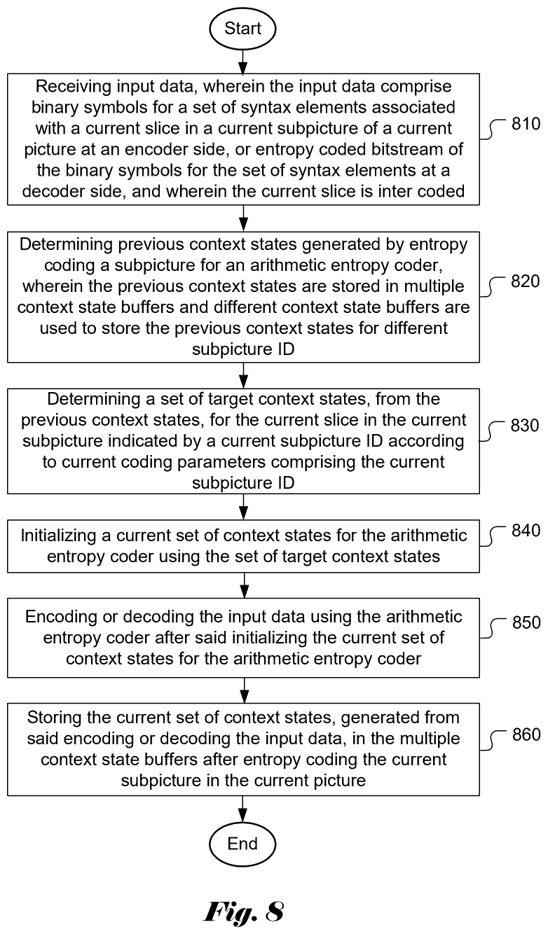

FIG. 8 illustrates a flowchart of an exemplary video coding system that uses multiple sets of context states for initialization of entropy coding subpictures according to an embodiment of the present invention. According to this method, input data are received in step 810, wherein the input data comprise binary symbols for a set of syntax elements associated with a current slice in a current subpicture of a current picture at an encoder side, or entropy coded bitstream of the binary symbols for the set of syntax elements at a decoder side, and wherein the current slice is inter coded. Previous context states generated by entropy coding a subpicture are determined for an arithmetic entropy coder in step 820, wherein the previous context states are stored in multiple context state buffers and different context state buffers are used to store the previous context states for different subpicture ID. A set of target context states is determined in step 830, from the previous context states, for the current slice in the current subpicture indicated by a current subpicture ID according to current coding parameters comprising the current subpicture ID. A current set of context states for the arithmetic entropy coder is initialized using the set of target context states in step 840. The input data is encoded or decoded using the arithmetic entropy coder after said initializing the current set of context states for the arithmetic entropy coder in step 850. The current set of context states, generated from said encoding or decoding the input data, is stored in the multiple context state buffers after entropy coding the current subpicture in the current picture in step 860.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data, wherein the input data comprise binary symbols for a set of syntax elements associated with a current slice in a current subpicture of a current picture at an encoder side, or entropy coded bitstream of the binary symbols for the set of syntax elements at a decoder side, and wherein the current slice is inter coded;
determining previous context states for an arithmetic entropy coder, wherein one or more context state buffers are used to store the previous context states for initializing the arithmetic entropy coder;
when a subpicture coding tool is used for the current picture:
disabling initializing the arithmetic entropy coder using the previous context states stored in said one or more context state buffers; and
encoding or decoding the input data using the arithmetic entropy coder.

2. The method of claim 1, wherein when the subpicture coding tool is used for the current picture, the arithmetic entropy coder is initialized by using pre-defined context states.

3. The method of claim 1, further comprising when the subpicture coding tool is used for the current picture, generating a conforming bitstream at the encoder side or receiving the conforming bitstream at the decoder side, wherein syntax information always indicates initialization of context states using the previous context states stored in said one or more context state buffers is disabled.

4. A method of video coding, the method comprising:
receiving input data, wherein the input data comprise binary symbols for a set of syntax elements associated with a current slice in a current subpicture of a current picture at an encoder side, or entropy coded bitstream of the binary symbols for the set of syntax elements at a decoder side, and wherein the current slice is inter coded;
determining previous context states for an arithmetic entropy coder, wherein one or more context state buffers are used to store the previous context states for initializing the arithmetic entropy coder;
initializing the arithmetic entropy coder by using the previous context states stored in said one or more context state buffers, wherein only the previous context states generated after entropy coding one or more previous inter slices corresponding to a same subpicture index of a coded previous subpicture as a current subpicture index of the current subpicture are allowed for said initializing the arithmetic entropy coder; and
encoding or decoding the input data using the arithmetic entropy coder.

5. The method of claim 4, wherein when a set of context states associated with the current subpicture index for the current subpicture is not available in the previous context states, the arithmetic entropy coder is not initialized using the previous context states for entropy coding one or more inter slices in the current subpicture.

6. A method of video coding, the method comprising:
receiving input data, wherein the input data comprise binary symbols for a set of syntax elements associated with a current slice in a current subpicture of a current picture at an encoder side, or entropy coded bitstream of the binary symbols for the set of syntax elements at a decoder side, and wherein the current slice is inter coded;
determining previous context states generated by entropy coding a subpicture for an arithmetic entropy coder, wherein the previous context states are stored in multiple context state buffers and different context state buffers are used to store the previous context states for different subpicture ID;
determining a set of target context states, from the previous context states, for the current slice in the current subpicture indicated by a current subpicture ID according to current coding parameters comprising the current subpicture ID;
initializing a current set of context states for the arithmetic entropy coder using the set of target context states;
encoding or decoding the input data using the arithmetic entropy coder after said initializing the current set of context states for the arithmetic entropy coder; and
storing the current set of context states, generated from said encoding or decoding the input data, in the multiple context state buffers after entropy coding the current subpicture in the current picture.

7. The method of claim 6, wherein the previous context states generated from entropy coding one subpicture having a same slice type, a same QP, a same temporal ID, and a same subpicture ID as corresponding values of respective slice type, QP, temporal ID, and subpicture ID associated with the current slice are stored in one context state buffer.

8. The method of claim 6, wherein each of the multiple context state buffers only stores one or more sets of context states generated from entropy coding one or more subpictures corresponding to the same subpicture ID in a coded video sequence.

9. The method of claim 6, wherein the set of target context states is derived from two or more sets of context states stored in the multiple context state buffers.

10. The method of claim 9, wherein one or more syntaxes are signalled or parsed to indicate said two or more sets of context states used to derive the set of target context states.

11. The method of claim 6, wherein the multiple context state buffers correspond to a four-dimensional array of context state buffers with a slice type, a temporal ID, a layer ID and a subpicture ID as four dimensions.

12. The method of claim 11, wherein different values of maximum context state buffer sizes are set for the different context state buffers.

13. The method of claim 12, wherein the maximum context state buffer sizes are pre-defined.

14. The method of claim 12, wherein the maximum context state buffer sizes are explicitly signalled or parsed in a high-level syntax of a bitstream.

15. The method of claim 6, wherein a total context state buffer size is limited by one or more constraints defined for a particular profile, tier, or level associated with a current coded video sequence.

16. An apparatus of video coding, the apparatus comprising one or more electronic circuits or processors arranged to:
receive input data, wherein the input data comprise binary symbols for a set of syntax elements associated with a current slice in a current subpicture of a current picture at an encoder side, or entropy coded bitstream of the binary symbols for the set of syntax elements at a decoder side, and wherein the current slice is inter coded;
determine previous context states for an arithmetic entropy coder, wherein one or more context state buffers are used to store the previous context states for initializing the arithmetic entropy coder;
when a subpicture coding tool is used for the current picture:
disable initializing the arithmetic entropy coder using the previous context states stored in said one or more context state buffers; and
encode or decode the input data using the arithmetic entropy coder.

17. An apparatus of video coding, the apparatus comprising one or more electronic circuits or processors arranged to:
receive input data, wherein the input data comprise binary symbols for a set of syntax elements associated with a current slice in a current subpicture of a current picture at an encoder side, or entropy coded bitstream of the binary symbols for the set of syntax elements at a decoder side, and wherein the current slice is inter coded;
determine previous context states for an arithmetic entropy coder, wherein one or more context state buffers are used to store the previous context states for initializing the arithmetic entropy coder;
initialize the arithmetic entropy coder by using the previous context states stored in said one or more context state buffers, wherein only the previous context states generated after entropy coding one or more previous inter slices corresponding to a same subpicture index of a coded previous subpicture as a current subpicture index of the current subpicture are allowed for said initializing the arithmetic entropy coder; and
encode or decode the input data using the arithmetic entropy coder.

18. (canceled)
